(19) United States
(12) Patent Application Publication
(10) Pub. No.: US 2024/0322255 A1
(43) Pub. Date: Sep. 26, 2024

(54) SECONDARY BATTERY AND ELECTRONIC APPARATUS

(71) Applicant: Ningde Amperex Technology Limited, Ningde (CN)

(72) Inventor: Xiaoming XU, Ningde (CN)

(73) Assignee: Ningde Amperex Technology Limited, Ningde (CN)

(21) Appl. No.: 18/612,029

(22) Filed: Mar. 21, 2024

(30) Foreign Application Priority Data
Mar. 22, 2023 (CN) 202310286443.0

(51) Int. Cl. H01M 10/0569; H01M 4/525; H01M 4/587; H01M 10/04; H01M 4/02

(52) U.S. Cl. CPC H01M 10/0569; H01M 4/525; H01M 4/587; H01M 10/0427; H01M 2004/027; H01M 2004/028; H01M 2220/30

(57) ABSTRACT

A secondary battery includes a positive electrode, a negative electrode, and an electrolyte. The positive electrode includes a positive electrode active material. The positive electrode active material is a lithium cobalt oxide-based material. The negative electrode includes a negative electrode active material. The negative electrode active material is natural graphite and artificial graphite, where a mass percentage of the natural graphite is 5% to 30% based on mass of the negative electrode active material. The electrolyte includes propylene carbonate, where a mass percentage of the propylene carbonate is 1% to 11% based on mass of the electrolyte. The secondary battery, through a reasonable combination of positive and negative electrode active materials and the electrolyte system, matches the decay rate of the negative electrode with that of the positive electrode during high-voltage cycling, greatly enhancing the cycling performance of the secondary battery at high voltages.

### CROSS-REFERENCE TO RELATED APPLICATION

The present application claims priority from Chinese Patent Application No. 202310286443.0, filed on Mar. 22, 2023, the disclosure of which is hereby incorporated by reference in its entirety.

### TECHNICAL FIELD

This application relates to the field of energy storage. Specifically, this application relates to a secondary battery and an electronic apparatus.

### BACKGROUND

Further enhancement of the energy density of lithium-ion batteries is of great significance, and increasing the capacity of the positive electrode is the most direct and effective way to improve energy density. Currently, this is often achieved by raising the charging voltage of lithium cobalt oxide, which increases the amount of lithium deintercalation of lithium cobalt oxide and thus improves the capacity of the positive electrode. However, when the charging voltage of lithium cobalt oxide batteries is raised to above 4.5V, irreversible phase changes in the positive electrode lithium cobalt oxide material occur (leading to lattice oxygen release or cobalt dissolution), along with a series of problems such as high-voltage decomposition of the electrolyte, resulting in rapid capacity decay during cycling (especially at high temperatures).

Existing technologies for modifying high-voltage lithium cobalt oxide positive electrodes mainly focus on material modification, such as doping with metal elements and surface coating to enhance their stability at high voltages. However, it is difficult for these modification methods to completely solve the problems that arise at high voltages (especially when the voltage exceeds 4.5V).

### SUMMARY

In view of the above problems in the existing technology, this application provides a secondary battery and an electronic apparatus including such secondary battery. The secondary battery of this application, through a reasonable combination of positive and negative electrode active materials and the electrolyte system, matches the decay rate of the negative electrode with that of the positive electrode during high-voltage cycling, greatly enhancing the cycling performance of the secondary battery at high voltages.

A first aspect of this application provides a secondary battery. The secondary battery includes a positive electrode, a negative electrode, and an electrolyte. The positive electrode includes a positive electrode active material, the positive electrode active material being a lithium cobalt oxide-based material. The negative electrode includes a negative electrode active material, the negative electrode active material being natural graphite and artificial graphite, where the mass percentage of the natural graphite is 5% to 30% based on mass of the negative electrode active material. The electrolyte includes propylene carbonate, where the mass percentage of the propylene carbonate is 1% to 11% based on mass of the electrolyte. During a high-voltage cycling process, the decay rate on the positive electrode side of the secondary battery accelerates, exceeding that of the negative electrode, causing the potential of the positive electrode to be continuously raised, leading to loss of CB (Cell Balance), and further accelerating the decay of the positive electrode. The inventors of this application have found that due to the numerous internal pores in natural graphite, molecules of propylene carbonate (PC) as solvent of the electrolyte can intercalate, leading to accelerated cycling decay. Therefore, this application introduces a certain amount of natural graphite into the negative electrode active material to adjust the decay rate of the negative electrode, matching it with that of the positive electrode during high-voltage cycling, avoiding too rapid an increase in polarization of the positive electrode, and thus achieving excellent cycling stability of the secondary battery at a full charge voltage ≥4.5V.

In some embodiments, based on the mass of the negative electrode active material, the mass percentage of the natural graphite is 10% to 30%. When the natural graphite content is too high, the intercalation of too many PC molecules during cycling can cause severe expansion of the negative electrode, destabilize the negative electrode interface, increase side reactions, increase electrolyte consumption, and significantly accelerate the decay of the negative electrode, thereby affecting the cycling performance of the secondary battery. In some embodiments, the mass percentage of the natural graphite is 15% to 25%.

In some embodiments, based on the mass of the electrolyte, the mass percentage of the propylene carbonate is 3% to 10%. When the mass percentage of the propylene carbonate is too low, the low-temperature discharge and high-temperature storage performance of the secondary battery may be affected. When the mass percentage of the propylene carbonate is too high, it may affect the side reactions caused by PC co-intercalation, which is not conducive to the overall cycling performance of the secondary battery. In some embodiments, the mass percentage of the propylene carbonate is 4% to 8%.

In some embodiments, the negative electrode further includes binders, the binders including a first binder and a second binder, where the first binder is selected from at least one of styrene-butadiene rubber polymers, and the second binder is selected from at least one of polyacrylic acid polymers. This application further introduces a polyacrylic acid polymer binder in addition to the conventional styrene-butadiene rubber binder, which can effectively reduce interface side reactions, reduce electrolyte consumption, and thereby enhance the cycling performance of the secondary battery.

In some embodiments, a mass ratio of the first binder to the second binder is 1:(0.2-4). In some embodiments, the mass ratio of the first binder to the second binder is 1:(0.2-3).

In some embodiments, the second binder includes structural unit A,

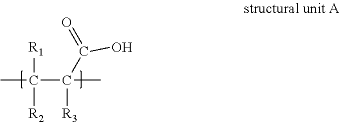

where R₁ to R₃ are each independently selected from hydrogen or C1-C4 alkyl groups. In some embodiments, the second binder is selected from polyacrylic acid.

In some embodiments, the first binder includes structural unit B and structural unit C,

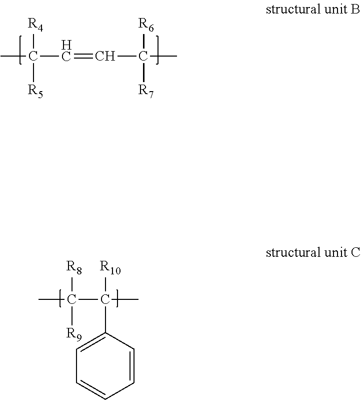

where R₄ to R₁₀ are each independently selected from hydrogen or C1-C4 alkyl groups. In some embodiments, the first binder is selected from styrene-butadiene rubber.

In some embodiments, the lithium cobalt oxide-based material is selected from at least one of lithium cobalt oxide, lithium cobalt oxide modified by doping, and lithium cobalt oxide modified by coating.

In some embodiments, the negative electrode and the electrolyte are assembled with lithium metal to form a first button cell battery, the first button cell battery having a capacity decay rate A in the voltage range of 0.005V to 0.8V, and the positive electrode and the electrolyte are assembled with lithium metal to form a second button cell battery, the second button cell battery having a capacity decay rate B in the voltage range of 3.0V to 4.6V, where 0.8≤A/B≤1.3.

In some embodiments, a full charge voltage of the secondary battery is greater than or equal to 4.5V.

A second aspect of this application provides an electronic apparatus including the secondary battery of the first aspect.

The overall design of the secondary battery of this application is basically consistent with that of conventional secondary batteries, without the need for significant changes. Through adjustment of only a few technical elements such as natural graphite, binder, and PC solvent in the electrolyte, the decay rates of the positive and negative electrodes are matched, thereby significantly enhancing the high-temperature cycling performance at voltages above 4.5V.

### BRIEF DESCRIPTION OF DRAWINGS

FIG. 1 shows cycling curves of secondary batteries of example 1 and comparative example 1 of this application;

FIG. 2 shows cycling curves of secondary batteries of example 2 and comparative example 1 of this application;

FIG. 3 shows cycling curves of secondary batteries of example 3 and comparative example 1 of this application; and

FIG. 4 shows cycling curves of secondary batteries of comparative example 1 and comparative example 2 of this application.

In the drawings, data for examples 1-3 and comparative examples 1-2 were obtained through parallel tests of four groups of secondary batteries.

### DETAILED DESCRIPTION

Embodiments of this application are described in detail below. The embodiments of this application should not be construed as a limitation on this application.

Additionally, sometimes in this application, quantities, ratios, and other numerical values are presented in a range format. It should be understood that such range formats are used for convenience and simplicity and should be flexibly understood as including not only values clearly designated as falling within the range but also all individual values or sub-ranges covered by the range as if each value and sub-range are clearly designated.

In the specific embodiments and claims, an item list connected by the terms “at least one of”, “at least one piece of”, “at least one type of” or other similar terms may mean any combination of the listed items. For example, if items A and B are listed, the phrase “at least one of A and B” means only A; only B; or A and B. In another example, if items A, B, and C are listed, the phrase “at least one of A, B, or C” means only A; only B; only C; A and B (exclusive of C); A and C (exclusive of B); B and C (exclusive of A); or all of A, B, and C. The item A may contain a single element or a plurality of elements. The item B may contain a single element or a plurality of elements. The item C may contain a single element or a plurality of elements.

### I. Secondary Battery

A first aspect of this application provides a secondary battery. The secondary battery includes a positive electrode, a negative electrode, and an electrolyte. The positive electrode includes a positive electrode active material, the positive electrode active material being a lithium cobalt oxide-based material; the negative electrode includes a negative electrode active material, the negative electrode active material being natural graphite and artificial graphite, where the mass percentage of the natural graphite is 5% to 30% based on mass of the negative electrode active material; the electrolyte includes propylene carbonate, where the mass percentage of the propylene carbonate is 1% to 11% based on mass of the electrolyte. During a high-voltage cycling process, the decay rate on the positive electrode side of the secondary battery accelerates, exceeding that of the negative electrode, causing the potential of the positive electrode to be continuously raised, leading to loss of CB (Cell Balance), and further accelerating the decay of the positive electrode. The inventors of this application have found that due to the numerous internal pores in natural graphite, molecules of propylene carbonate (PC) solvent of the electrolyte can intercalate, leading to accelerated cycling decay. Therefore, this application introduces a certain amount of natural graphite into the negative electrode active material to adjust the decay rate of the negative electrode, matching it with that of the positive electrode during high-voltage cycling, avoiding too rapid an increase in polarization of the positive electrode, and thus achieving excellent cycling stability of the secondary battery at a full charge voltage ≥4.5V.

In some embodiments, based on the mass of the negative electrode active material, the mass percentage of the natural graphite is 5%, 10%, 11%, 12%, 13%, 14%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 26%, 27%, 28%, 29%, 30%, or any range defined by any two of these values. In some embodiments, based on the mass of the negative electrode active material, the mass percentage of the natural graphite is 10% to 30%. When the natural graphite content is too high, the intercalation of too many PC molecules during cycling can cause severe expansion of the negative electrode, destabilize the negative electrode interface, increase side reactions, increase electrolyte consumption, and significantly accelerate the decay of the negative electrode, thereby affecting the cycling performance of the secondary battery. In some embodiments, the mass percentage of the natural graphite is 15% to 25%.

In some embodiments, based on the mass of the electrolyte, the mass percentage of the propylene carbonate is 1%, 2%, 3%, 3.5%, 4%, 4.5%, 5%, 5.5%, 6%, 6.5%, 7%, 7.5%, 8%, 9%, 10%, 10.5%, 11%, or any range defined by any two of these values. In some embodiments, based on the mass of the electrolyte, the mass percentage of the propylene carbonate is 3% to 10%. When the mass percentage of the propylene carbonate is too low, the low-temperature discharge and high-temperature storage performance of the secondary battery may be affected. When the mass percentage of the propylene carbonate is too high, it may affect the side reactions caused by PC co-intercalation, which is not conducive to the overall cycling performance of the secondary battery. In some embodiments, the mass percentage of the propylene carbonate is 4% to 8%.

In some embodiments, the negative electrode further includes a binder. The binder includes a first binder and a second binder, where the first binder is selected from at least one of styrene-butadiene rubber polymers, and the second binder is selected from at least one of polyacrylic acid polymers. This application further introduces a polyacrylic acid polymer binder in addition to the conventional styrene-butadiene rubber binder, which can effectively reduce interface side reactions, reduce electrolyte consumption, and thereby enhance the cycling performance of the secondary battery.

In some embodiments, a mass ratio of the first binder to the second binder is 1:(0.2-4). In some embodiments, the mass ratio of the first binder to the second binder is 1:0.2, 1:0.3, 1:0.5, 1:0.7, 1:0.9, 1:1, 1:1.3, 1:1.5, 1:1.7, 1:1.9, 1:2, 1:2.3, 1:2.5, 1:2.7, 1:2.9, 1:3, 1:3.3, 1:3.5, 1:3.7, 1:3.9, 1:4, or any range defined by any two of these values. In some embodiments, the mass ratio of the first binder to the second binder is 1:(0.2-3).

In some embodiments, the second binder includes structural unit A,

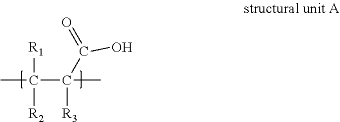

where R₁ to R₃ are each independently selected from hydrogen or C1-C4 alkyl groups.

In some embodiments, R₁ to R₃ are each independently selected from hydrogen, methyl, ethyl, n-propyl, or isopropyl. In some embodiments, the second binder is selected from polyacrylic acid or methacrylic acid.

In some embodiments, the first binder includes structural unit B and structural unit C,

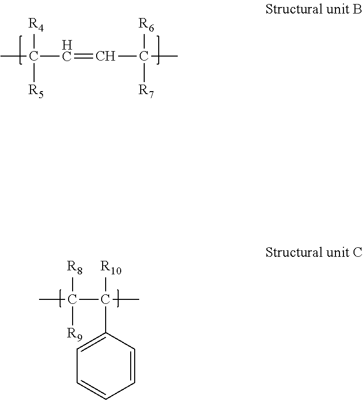

where R₄ to R₁₀ are each independently selected from hydrogen or C1-C4 alkyl groups.

In some embodiments, R₄ to R₇ are each independently selected from hydrogen, methyl, ethyl, n-propyl, or isopropyl. In some embodiments, R₈ to R₁₀ are each independently selected from hydrogen, methyl, ethyl, n-propyl, or isopropyl. In some embodiments, the first binder is selected from styrene-butadiene rubber.

In some embodiments, the lithium cobalt oxide-based material is selected from at least one of lithium cobalt oxide, lithium cobalt oxide modified by doping, and lithium cobalt oxide modified by coating.

In some embodiments, the lithium cobalt oxide modified by doping includes at least one of Li₁₋ₓMₓCoO₂, where M is selected from aluminum, magnesium, titanium, tin, vanadium, copper, zinc, zirconium, chromium, manganese, iron, gallium, molybdenum, antimony, tungsten, yttrium, and niobium, with 0<x≤0.05.

In some embodiments, the lithium cobalt oxide modified by coating includes lithium cobalt oxide and a coating layer located on the surface of lithium cobalt oxide. In some embodiments, the material of the coating layer includes at least one of oxides, hydroxides, carbonates, nitrates, oxalates, acetates, phosphates, silicates, and manganates containing element N, where element N is selected from at least one of lithium, aluminum, magnesium, titanium, zirconium, lanthanum, niobium, tungsten, yttrium, vanadium, oxygen, phosphorus, silicon, sulfur, fluorine, iodine, and nitrogen.

In some embodiments, the negative electrode and the electrolyte are assembled with lithium metal to form a first button cell battery, the first button cell battery having a capacity decay rate A in the voltage range of 0.005V to 0.8V, and the positive electrode and the electrolyte are assembled with lithium metal to form a second button cell battery, the second button cell battery having a capacity decay rate B in the voltage range of 3.0V to 4.6V, where 0.8≤A/B≤1.3. In some embodiments, A/B is 0.8, 0.85, 0.9, 0.95, 1.0, 1.05, 1.1, 1.15, 1.2, 1.25, or 1.3.

In some embodiments, a full charge voltage of the secondary battery is greater than or equal to 4.5V.

In some embodiments, the negative electrode further includes a conductive agent. In some embodiments, the conductive agent includes, but is not limited to: carbon-based materials, metal-based materials, conductive polymers, and their mixtures. In some embodiments, the carbon-based material is selected from natural graphite, artificial graphite, carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative.

In some embodiments, the negative electrode further includes a negative electrode current collector. The negative electrode current collector includes: copper foil, aluminum foil, nickel foil, stainless steel foil, titanium foil, nickel foam, copper foam, a polymer substrate coated with a conductive metal, or any combination thereof.

In some embodiments, the positive electrode further includes a binder. The binder includes an adhesive polymer, such as at least one of polyvinylidene fluoride, polytetrafluoroethylene, polyolefin, sodium carboxymethyl cellulose, lithium carboxymethyl cellulose, modified polyvinylidene fluoride, modified SBR rubber, or polyurethane. In some embodiments, the polyolefin binder includes at least one of polyethylene, polypropylene, polyester, polyvinyl alcohol, or polyacrylic acid.

In some embodiments, the positive electrode further includes a conductive agent. The conductive agent includes a carbon-based material, such as natural graphite, artificial graphite, carbon black, acetylene black, Ketjen black, or carbon fiber; a metal-based material, such as metal powder or metal fiber of copper, nickel, aluminum, silver, or the like; a conductive polymer, such as a polyphenylene derivative; or their mixtures.

In some embodiments, the positive electrode further includes a positive electrode current collector. The positive electrode current collector can be a metal foil or a composite current collector. For example, an aluminum foil may be used. The composite current collector may be formed by forming a metal material (copper, copper alloy; nickel, nickel alloy, titanium, titanium alloy, silver, silver alloy, or the like) on a polymer matrix.

In some embodiments, the electrolyte includes an organic solvent, a lithium salt, and an optional additive. The electrolytic salt used in the electrolyte according to this application is not limited and may be any electrolytic salt known in the prior art. The additive of the electrolyte according to this application may be any additive known in the prior art which can be used as an additive of the electrolyte.

In some embodiments, the organic solvent further includes, but is not limited to: ethylene carbonate (EC), diethyl carbonate (DEC), ethyl methyl carbonate (EMC), dimethyl carbonate (DMC), propylene carbonate, or ethyl acetate. In some embodiments, the organic solvent includes an ether solvent, such as at least one of 1,3-dioxolane (DOL) and ethylene glycol dimethyl ether (DME).

In some embodiments, the lithium salt includes at least one of an organic lithium salt or an inorganic lithium salt. In some embodiments, the lithium salt includes, but is not limited to: lithium hexafluorophosphate (LiPF₆), lithium tetrafluoroborate (LiBF₄), lithium difluorophosphate (LiPO₂F₂), lithium bis(trifluoromethanesulfonyl)imide LiN(CF₃SO₂)₂ (LiTFSI), lithium bis(fluorosulfonyl)imide Li(N(SO₂F)₂) (LIFSI), lithium bis(oxalato)borate LiB(C₂O₄)₂ (LiBOB), or lithium difluoro(oxalato)borate LiBF₂(C₂O₄) (LiDFOB). In some embodiments, the additive includes at least one of fluoroethylene carbonate and adiponitrile.

The secondary battery of this application also includes a separator. The material and shape of the separator used in the secondary battery of this application are not particularly limited and can be any technology disclosed in the prior art. In some embodiments, the separator includes a polymer or an inorganic substance formed by a material stable to the electrolyte of this application.

For example, the separator may include a substrate layer and a surface treatment layer. The substrate layer is a non-woven fabric, a membrane, or a composite membrane having a porous structure, and the material of the substrate layer is selected from at least one of polyethylene, polypropylene, polyethylene terephthalate, or polyimide. Specifically, a polypropylene porous membrane, a polyethylene porous membrane, a polypropylene non-woven fabric, a polyethylene non-woven fabric, or a polypropylene-polyethylene-polypropylene porous composite membrane may be selected.

The surface treatment layer is provided on at least one surface of the substrate layer, and the surface treatment layer may be a polymer layer or an inorganic layer or may be a layer formed by a mixed polymer and an inorganic substance. The inorganic substance layer includes inorganic particles and a binder. The inorganic particles are selected from at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, a vinylidene fluoride-hexafluoropropylene copolymer, polyamide, polyacrylonitrile, polyacrylate, polyacrylic acid, polyacrylate, polyvinylpyrrolidone, polyvinyl ether, polymethyl methacrylate, polytetrafluoroethylene, or polyhexafluoropropylene. The polymer layer includes a polymer, and the material of the polymer is selected from at least one of polyamide, polyacrylonitrile, an acrylate polymer, polyacrylic acid, polyacrylate, polyvinylpyrrolidone, polyvinyl ether, polyvinylidene fluoride, or poly(vinylidene fluoride-hexafluoropropylene).

In some embodiments, the secondary battery of this application includes, but is not limited to: a lithium-ion battery or a sodium-ion battery. In some embodiments, the secondary battery includes a lithium-ion battery.

### II. Electronic Apparatus

This application further provides an electronic apparatus, which includes the secondary battery of the first aspect of this application.

The electronic device or apparatus in this application is not particularly limited. In some embodiments, the electronic device of this application includes, but is not limited to: a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a memory card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, a lithium-ion capacitor, or the like.

In the following examples and comparative examples, unless otherwise specified, the reagents, materials, and instruments used can be commercially obtained.

### EXAMPLES AND COMPARATIVE EXAMPLES

### Example 1

### <Preparation of Negative Electrode Plate>

Negative electrode active material (10 wt % natural graphite and 90 wt % artificial graphite), binder (PAA and SBR, where SBR/PAA=1:2), and other components (conductive agent and dispersant) were mixed in a mass ratio of 97:1.7:1.3, deionized water was added, and the mixture was subjected to vacuum stirring to obtain a negative electrode slurry, where a solid content of the negative electrode slurry was 49 wt %.

The negative electrode slurry was uniformly applied on one surface of a negative electrode current collector copper foil with a thickness of 6 μm, the copper foil was dried at 85° C. to obtain a negative electrode plate with a coating thickness of 80 μm on one side, and the above steps were repeated on the other surface of the negative electrode current collector to obtain a negative electrode plate coated with a negative electrode material layer on both sides, which was then cold-pressed and set aside.

### <Preparation of Positive Electrode Plate>

Positive electrode active material lithium cobalt oxide, conductive carbon black, and binder polyvinylidene fluoride were mixed in a mass ratio of 96.7:1.7:1.6, then N-methyl-2-pyrrolidone (NMP) was added, and the mixture was subjected to vacuum stirring to obtain a positive electrode slurry; where a solid content of the positive electrode slurry was 76 wt %. The positive electrode slurry was uniformly applied on one surface of a positive electrode current collector aluminum foil with a thickness of 9 μm, and the aluminum foil was dried at 120° C. to obtain a positive electrode plate with a coating thickness of 45 μm on one side. The above steps were repeated on the other surface of the aluminum foil to obtain a positive electrode plate coated with a positive electrode material layer on both sides, which was then cold-pressed and set aside.

### <Preparation of Electrolyte>

In a dry argon atmosphere glove box, ethylene carbonate, propylene carbonate, dimethyl carbonate, and ethyl methyl carbonate were mixed in a mass ratio of 3.0:0.6:4.2:2.2 to obtain an organic solvent, then lithium salt LiPF₆ and additive fluoroethylene carbonate were dissolved and mixed evenly in the organic solvent to obtain an electrolyte. Based on mass of the electrolyte, the mass percentage of LiPF₆ was 12.5%, and the mass percentage of propylene carbonate was 5%.

### <Preparation of Separator>

A porous polyethylene film with a thickness of 7 μm (provided by Celgard company), with a pore size of 0.1 μm, was used as the separator. The surface of the separator film was coated with a polyacrylate binder layer, with a coating weight of 10±2 mg/5000 mm² and a thickness of 3±1 μm.

### <Preparation of Lithium-Ion Pouch Cell>

The prepared positive electrode plate, separator, and negative electrode plate were stacked in sequence, so that the separator was sandwiched between the positive electrode plate and the negative electrode plate for separation. Then, the stack was wound to obtain an electrode assembly. The electrode assembly was placed in a pouch made of aluminum-plastic film, then electrolyte was injected, and the cell was sealed. After formation and other processes, a lithium-ion battery was obtained.

### Examples 2 to 12 and Comparative Examples 1 to 4

Except for the adjustments to the relevant preparation parameters as shown in Table a, the rest was the same as in Example 1.

TABLE a

| | Types and | | | |
|---|---|---|---|---|
| Example or | contents of | | Propylene | |
| comparative | negative electrode | Binder type and mass | carbonate | |
| example | active material | ratio | content | |
| Example 1 | 10 wt % natural | Styrene-butadiene | 5 | wt % |
| | graphite + 90 wt % | rubber + polyacrylic | | |
| | artificial graphite | acid | | |
| | | 1:2 | | |
| Example 2 | 20 wt % natural | Styrene-butadiene | 5 | wt % |
| | graphite + 80 wt % | rubber + polyacrylic | | |
| | artificial graphite | acid | | |
| | | 1:3 | | |
| Example 3 | 30 wt % natural | Styrene-butadiene | 5 | wt % |
| | graphite + 70 wt % | rubber + polyacrylic | | |
| | artificial graphite | acid | | |
| | | 1:3 | | |
| Example 4 | 10 wt % natural | Styrene-butadiene | 3 | wt % |
| | graphite + 90 wt % | rubber + polyacrylic | | |
| | artificial graphite | acid | | |
| | | 1:2 | | |
| Example 5 | 10 wt % natural | Styrene-butadiene | 10 | wt % |
| | graphite + 90 wt % | rubber + polyacrylic | | |
| | artificial graphite | acid | | |
| | | 1:4 | | |
| Example 6 | 30 wt % natural | Styrene-butadiene | 1 | wt % |
| | graphite + 70 wt % | rubber + polyacrylic | | |
| | artificial graphite | acid | | |
| | | 1:4 | | |
| Example 7 | 5 wt % natural | Styrene-butadiene | 5 | wt % |
| | graphite + 95 wt % | rubber + polyacrylic | | |
| | artificial graphite | acid | | |
| | | 1:0.25 | | |
| Example 8 | 5 wt % natural | Styrene-butadiene | 5 | wt % |
| | graphite + 95 wt % | rubber + polyacrylic | | |
| | artificial graphite | acid | | |
| | | 1:3 | | |
| Example 9 | 10 wt % natural | Styrene-butadiene | 5 | wt % |
| | graphite + 90 wt % | rubber + polyacrylic | | |
| | artificial graphite | acid | | |
| | | 1:3 | | |
| Example 10 | 10 wt % natural | Styrene-butadiene | 1 | wt % |
| | graphite + 90 wt % | rubber + polyacrylic | | |
| | artificial graphite | acid | | |
| | | 1:2 | | |
| Example 11 | 10 wt % natural | Styrene-butadiene | 7 | wt % |
| | graphite + 90 wt % | rubber + polyacrylic | | |
| | artificial graphite | acid | | |
| | | 1:2 | | |
| Example 12 | 10 wt % natural | Styrene-butadiene | 10 | wt % |
| | graphite + 90 wt % | rubber + polyacrylic | | |
| | artificial graphite | acid | | |
| | | 1:2 | | |
| Comparative | 100 wt % artificial | Styrene-butadiene | 20 | wt % |
| Example 1 | graphite | rubber | | |
| Comparative | 50 wt % natural | Styrene-butadiene | 15 | wt % |
| Example 2 | graphite + 50 wt % | rubber + polyacrylic | | |
| | artificial graphite | acid | | |
| | | 1:2 | | |
| Comparative | 40 wt % natural | Styrene-butadiene | 5 | wt % |
| Example 3 | graphite + 60 wt % | rubber + polyacrylic | | |
| | artificial graphite | acid | | |
| | | 1:3 | | |
| Comparative | 10 wt % natural | Styrene-butadiene | 15 | wt % |
| Example 4 | graphite + 90 wt % | rubber + polyacrylic | | |
| | artificial graphite | acid | | |
| | | 1:2 | | |

### Test Method

### 1. Testing the Relative Content of Artificial Graphite and Natural Graphite

The relative content of artificial graphite and natural graphite was measured by scanning electron microscopy (SEM) cross-sectional analysis. Microscopically, natural graphite has a layered structure, and its SEM cross-sectional images retain the layered structure of flake graphite, with a large number of voids between the flake structures; whereas artificial graphite negative electrode material is coke or mesophase that rearranges and aggregates its crystal structure in an ABAB sequence during the high-temperature graphitization process, resulting in a dense interior without voids. Specifically,

A fully discharged lithium-ion battery was taken apart, and the negative electrode was soaked in DMC (dimethyl carbonate) for 20 minutes, then rinsed with DMC and acetone in turn to remove the electrolyte and the surface SEI film. Afterwards, it was placed in an oven and baked at 80° C. for 12 hours to obtain a treated negative electrode plate.

The preparation process for the cross-section sample of the negative electrode by ion milling: The treated negative electrode plate mentioned above was cut into a size of 0.5 cm×1 cm, and the cut negative electrode was glued onto a 1 cm×1.5 cm silicon wafer carrier using conductive adhesive. Then, argon ion polishing (parameters: 8 KV acceleration voltage, 4 hours for each sample) was used to process one end of the negative electrode plate. Argon ion polishing uses a high-voltage electric field to ionize argon gas into ions, which are accelerated under an acceleration voltage and bombard the surface of the negative electrode at high speed, stripping the negative electrode plate layer by layer to achieve a polishing effect.

The scanning electron microscope used in this application was a JSM-6360LV model from JEOL company, along with its supporting X-ray energy spectrometer, to collect cross-sectional images of the polished negative electrode plate. Image analysis was then performed. A 60 μm×80 μm cross-section was selected, and the area ratio of artificial graphite to natural graphite was calculated to determine the relative content of artificial graphite and natural graphite.

### 2. Propylene Carbonate Content in the Electrolyte

The propylene carbonate content in the electrolyte can be tested by gas chromatography-mass spectrometry (GC-MS) or gas chromatography-mass spectrometry combined analysis method. The electrolyte from a fully discharged lithium-ion battery was centrifuged and separated, then appropriately diluted, and the propylene carbonate content was measured by chromatographic analysis or mass spectrometric analysis.

### 3. Testing the Composition and Contents of Binders

Electrophoretic analysis can be used for testing. A fully discharged lithium-ion battery was taken apart, and the negative electrode was soaked in DMC (dimethyl carbonate) for 20 minutes, then rinsed with DMC and acetone in turn to remove the electrolyte and the surface SEI film. Afterwards, it was placed in an oven and baked at 80° C. for 12 hours to obtain a treated negative electrode plate.

First, the binders from the negative electrode plate were extracted using an ion exchange resin. Then, the binder solution was added to a brown glass container and analyzed using an electrophoresis instrument. The electrophoretic diagram of each component was measured to determine the composition and contents of the binders.

### 4. Testing the Ratio of Capacity Decay Rates of Positive and Negative Electrodes

A fully discharged lithium-ion battery was taken apart, and the positive and negative electrodes were soaked in DMC (dimethyl carbonate) for 20 minutes, then rinsed with DMC and acetone in turn to remove the electrolyte and the surface SEI film. Afterwards, they were placed in an oven and baked at 80° C. for 12 hours to obtain treated positive and negative electrode plates.

### (1) Testing the Capacity Decay Rate of the Negative Electrode:

### Step 1: Preparation of the Negative Electrode Plate

The negative electrode plate was punched into the required specific size of round pieces.

### Step 2: Button Cell Assembly

In an argon-filled glove box, the negative electrode plate prepared in step 1, the separator, and a lithium metal piece were stacked in a “sandwich” structure with the separator in the middle, placed in a button cell steel case, and the electrolyte was added (consistent with the electrolyte in the above examples), followed by sealing to assemble a button cell.

### Step 3: Cycling Test

The button cell assembled in step 2 was placed on a multi-channel battery testing system for testing, using a constant current charge and discharge process (as detailed below) at 45° C. for 100 cycles.

Constant current charge and discharge process: (This process is only an example, other similar processes commonly used in the field can also be used)
1) Stand for 5 minutes.
2) Charge at 0.5 C constant current to 0.8V.
3) Stand for 5 minutes.
4) Discharge at 0.2 C constant current to 0.005V.
5) Repeat steps 1) to 4) for 100 cycles.

### Step 4: Calculation of the Capacity Decay Rate

The capacity of the 100th cycle and the 2nd cycle were extracted, and the capacity decay rate was calculated using the following formula:

Capacity decay rate=(Capacity of 2nd cycle−Capacity of 100th cycle)/Capacity of 2nd cycle.

### (2) Testing the Capacity Decay Rate of the Positive Electrode:

### Step 1: Preparation of the Positive Electrode Plate

The positive electrode plate was punched into the required specific size of round pieces.

### Step 2: Button Cell Assembly

In an argon-filled glove box, the positive electrode plate prepared in step 1, the separator, and a lithium metal piece were stacked in a “sandwich” structure with the separator in the middle, placed in a button cell steel case, and the electrolyte was added (consistent with the electrolyte in the above examples), followed by sealing to assemble a button cell.

### Step 3: Cycling Test

The button cell assembled in step two was placed on a multi-channel battery testing system for testing, using a constant current charge and discharge process (as detailed below) at 45° C. for 100 cycles.

Constant current charge and discharge process: (This process is only an example, other similar processes commonly used in the field can also be used)
1) Stand for 5 minutes.
2) Charge at 0.5 C constant current to the full charge voltage (4.5V-4.6V, determined according to actual conditions).
3) Stand for 5 minutes.
4) Discharge at 0.2 C constant current to 3.0V.
5) Repeat steps 1) to 4) for 100 cycles.

### Step 4: Calculation of the Capacity Decay Rate

The capacity of the 100th cycle and the capacity of 2nd cycle were extracted, and the capacity decay rate was calculated using the following formula:

Capacity decay rate=(Capacity of 2nd cycle−Capacity of 100th cycle)/Capacity of 2nd cycle.

### 5. Lithium-Ion Battery Cycling Performance Test

The test temperature was 45° C., using a multi-channel battery testing system, and the following test process was used for charge and discharge testing. The discharge capacity of the second cycle was taken as the initial discharge capacity, and the capacity retention rate after n cycles was (the discharge capacity of the n-th cycle/initial discharge capacity)×100%.

### Charge and Discharge Process:

1) Stand for 30 minutes.
2) Charge at 1.5 C constant current to 4.25V, then constant voltage charge to 1 C.
3) Charge at 1 C constant current to 4.35V, then constant voltage charge to 0.7 C.
4) Charge at 0.7 C constant current to 4.5V, then constant voltage charge to 0.05 C.
5) Stand for 5 minutes.
6) Discharge at 0.7 C constant current to 3V.
7) Stand for 5 minutes.

### Test Results

Table 1 shows the impact of the type and contents of the negative electrode active material, the type and contents of the binder, and the propylene carbonate content in the electrolyte on performance, where A is the capacity decay rate of the negative electrode in the voltage range of 0.005V to 0.8V, and B is the capacity decay rate of the positive electrode in the voltage range of 3.0V to 4.6V.

TABLE 1

| | | | | | Lithium-Ion | |
|---|---|---|---|---|---|---|
| | | | Binder | | Battery | |
| | | | Ratio of | | Performance | |
| | Negative electrode | | styrene- | | | Cycles until |
| | active material | | butadiene | Electrolyte | | capacity |
| Example or | Natural | Artificial | rubber to | Propylene | | retention rate |
| comparative | graphite | graphite | polyacrylic | carbonate | | decreased |
| example | content | content | acid | content | A/B | to 80% |
| Example 1 | 10.3% | 89.7% | 1.03:2 | 5.02% | 1.02 | 590 |
| Example 2 | 19.9% | 80.1% | 1.05:3 | 5.02% | 1.07 | 600 |
| Example 3 | 30.0% | 70.0% | 1.05:3 | 5.02% | 1.21 | 550 |
| Example 4 | 10.3% | 89.7% | 1.03:2 | 3.1% | 0.98 | 520 |
| Example 5 | 10.3% | 89.7% | 1.08:4 | 10.3% | 1.05 | 580 |
| Example 6 | 30.0% | 70.0% | 1.08:4 | 0.99% | 0.91 | 510 |
| Example 7 | 5.1% | 94.9% | 1.01:0.25 | 5.02% | 0.95 | 560 |
| Example 8 | 5.1% | 94.9% | 1.05:3 | 5.02% | 0.88 | 500 |
| Example 9 | 10.3% | 89.7% | 1.05:3 | 5.02% | 0.95 | 560 |
| Example 10 | 10.3% | 89.7% | 1.03:2 | 0.99% | 0.90 | 510 |
| Example 11 | 10.3% | 89.7% | 1.03:2 | 6.95% | 1.10 | 570 |
| Example 12 | 10.3% | 89.7% | 1.03:2 | 10.3% | 1.28 | 540 |
| Comparative | 0 | 100% | / | 20.9% | 0.68 | 460 |
| example 1 | | | | | | |
| Comparative | 52.1% | 47.9% | 1.03:2 | 15.5% | 1.75 | 390 |
| example 2 | | | | | | |
| Comparative | 41.5% | 58.5% | 1.05:3 | 5.02% | 1.42 | 420 |
| example 3 | | | | | | |
| Comparative | 10.3% | 89.7% | 1.03:2 | 15.5% | 1.44 | 440 |
| example 4 | | | | | | |

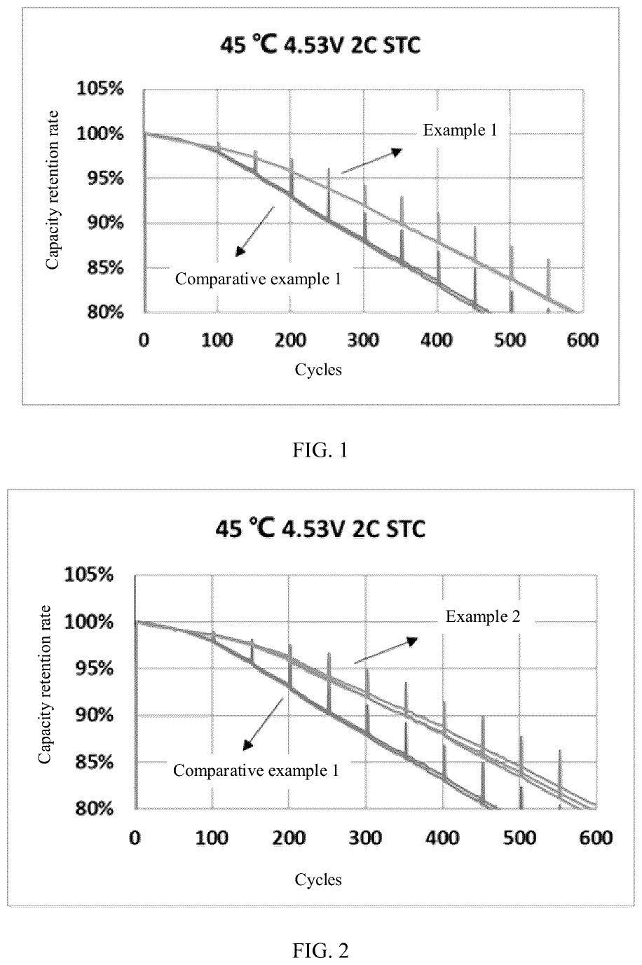

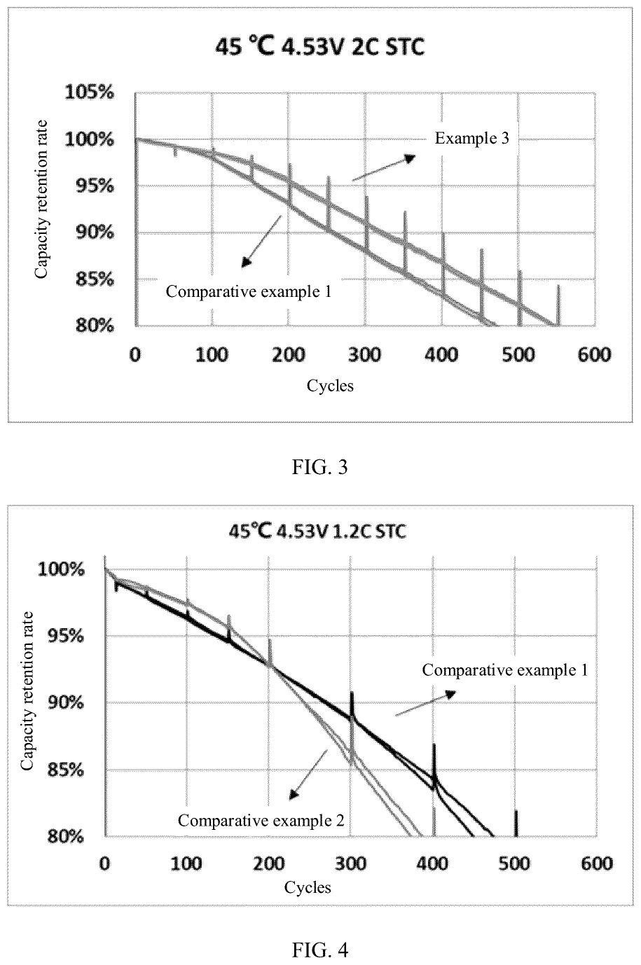

From the data of comparative example 1 and example 1 in Table 1 and FIG. 1, it can be seen that in comparative example 1, under 45° C. cycling, the decay rate of lithium cobalt oxide is significantly faster than that of graphite. As the cycles progress, the potential of the positive electrode will gradually increase, further accelerating the decay of lithium cobalt oxide, leading to a significant acceleration of the decay rate after about 100 cycles. In example 1, natural graphite was introduced into the negative electrode, and the PC content in the electrolyte was controlled to match the decay rate of the negative electrode with that of the positive electrode, avoiding the accelerated decay of lithium cobalt oxide on the positive electrode, and significantly improving the 45° C. cycling performance. The lithium-ion batteries obtained in examples 2 and 3 and the performance comparison with the comparative examples are shown in FIGS. 2 and 3, respectively, with the corresponding cycling performance being significantly improved, indicating the effectiveness of the key parameters of this application being within the defined range.

The cycling performance comparison between comparative example 2 and comparative example 1 is shown in FIG. 4. When the proportion of natural graphite is high at 50%, and the proportion of PC solvent in the electrolyte is 15%, the cycling performance for the first 100 cycles is still significantly improved compared to comparative example 1. However, due to the continuous increase in by-products and the continuous large consumption of electrolyte, the lithium-ion battery obtained in comparative example 2 shows a significant acceleration of decay after 100 cycles, and the number of cycles where the capacity retention rate reaches 80% is less than 400 cycles, which is a decrease compared to comparative example 1. This further demonstrates the importance of limiting the key parameters in this application.

Although some example embodiments of this application have been illustrated and described, this application is not limited to the disclosed embodiments. On the contrary, a person of ordinary skill in the art will recognize that some modifications and changes can be made to the embodiments without departing from the spirit and scope of this application described in the appended claims.

1. A secondary battery, comprising:
a positive electrode, the positive electrode comprising a positive electrode active material, wherein the positive electrode active material is a lithium cobalt oxide-based material;
a negative electrode, the negative electrode comprising a negative electrode active material, wherein the negative electrode active material is natural graphite and artificial graphite, and a mass percentage of the natural graphite is 5% to 30% based on a mass of the negative electrode active material; and
an electrolyte, the electrolyte comprising propylene carbonate, wherein a mass percentage of the propylene carbonate is 1% to 11% based on a mass of the electrolyte.

2. The secondary battery according to claim 1, wherein the mass percentage of the natural graphite is 10% to 30%; and/or the mass percentage of the propylene carbonate is 3% to 10%.

3. The secondary battery according to claim 1, wherein the mass percentage of the natural graphite is 15% to 25%; and/or the mass percentage of the propylene carbonate is 4% to 8%.

4. The secondary battery according to claim 1, wherein the negative electrode further comprises binders, the binders comprising a first binder and a second binder, wherein the first binder is selected from styrene-butadiene rubber polymers, and the second binder is selected from polyacrylic acid polymers, a mass ratio of the first binder to the second binder being 1:(0.2-4).

5. The secondary battery according to claim 4, wherein the mass ratio of the first binder to the second binder is 1:(0.2-3).

6. The secondary battery according to claim 4, wherein the second binder comprises a structural unit A, and the first binder comprises a structural unit B and a structural unit C, 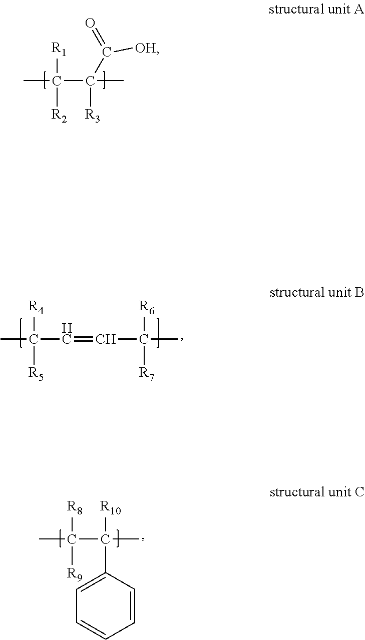
wherein, R₁ to R10 are each independently selected from hydrogen or C1-C4 alkyl groups.

7. The secondary battery according to claim 4, wherein the first binder is styrene-butadiene rubber, and the second binder is polyacrylic acid.

8. The secondary battery according to claim 1, wherein the lithium cobalt oxide-based material is at least one selected from the group consisting of lithium cobalt oxide, lithium cobalt oxide modified by doping, and lithium cobalt oxide modified by coating.

9. The secondary battery according to claim 1, wherein the negative electrode and the electrolyte are assembled with lithium metal to form a first button cell battery, the first button cell battery having a capacity decay rate A in the voltage range of 0.005V to 0.8V, and the positive electrode and the electrolyte are assembled with lithium metal to form a second button cell battery, the second button cell battery having a capacity decay rate B in the voltage range of 3.0V to 4.6V, wherein 0.8≤A/B≤1.3.

10. The secondary battery according to claim 1, wherein a full charge voltage of the secondary battery is greater than or equal to 4.5V.

11. An electronic apparatus comprising a secondary battery, the secondary battery comprises:
a positive electrode, the positive electrode comprising a positive electrode active material, wherein the positive electrode active material is a lithium cobalt oxide-based material;
a negative electrode, the negative electrode comprising a negative electrode active material, wherein the negative electrode active material is natural graphite and artificial graphite, and a mass percentage of the natural graphite is 5% to 30% based on mass of the negative electrode active material; and
an electrolyte, the electrolyte comprising propylene carbonate, wherein a mass percentage of the propylene carbonate is 1% to 11% based on mass of the electrolyte.
